(19) United States
(12) Patent Application Publication
(10) Pub. No.: US 2009/0063107 A1
(43) Pub. Date: Mar. 5, 2009

(54) Manufacturing Process of Hearing Aid Shells With Reduced Surface Distortions and Adaptive Shell Surface Modification to Improve Fit and Appertaining System

(75) Inventors: Oleg Saltykov, Fairlawn, NJ (US); Fred McBagonluri, East Windsor, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS HEARING INSTRUMENTS INC., Piscataway, NJ (US)

(21) Appl. No.: 11/846,103

(22) Filed: Aug. 28, 2007

(51) Int. Cl. G06F 17/10; H04R 31/00

(52) U.S. Cl. 703/2; 29/896.21

(57) ABSTRACT

A method and appertaining system is provided for reducing distortions in a hearing aid shell having complex surfaces with areas having high and low curvatures, the distortions occurring due to uneven material loss during tumbling and buffing operations. The method determines the curvature in defined regions of the shell and determines a new shell surface that is dependent upon the curvature in each respective region. Templates may be utilized th further define the new surface. With the new surface thus defined, the tumbling and buffing operations result in an end product having the desired shape.

### BACKGROUND

The present invention is directed to a method for manufacturing hearing aid shells in order to reduce surface distortions and to provide an adaptive shell surface modification to improve fit.

The issue of fit, i.e., whether a given hearing instrument designed from a mold of a patient's ear can fit the wearer comfortably after it has been produced, has been a great challenge to the hearing instruments industry. This challenge is the result of the interdependence of fit on many prevailing and competing parameters.

In modern hearing aid design, a rapid shell modelling (RSM) process is often utilized in which a three-dimensional model of the patient's ear canal is computed from a scanned ear canal impression. Such a model can be further manipulated by using sophisticated geometrical algorithms to obtain the finished hearing aid shell that can be produced in a matter of minutes. The production of a shell from a computer model can be achieved, e.g., by laser sintering in which a laser fuses liquid material into a solid in layers based on the shell model. However, this process (and other 3D manufacturing technologies) can create artifacts on the shell that must be removed.

One of the steps in the manufacturing of such a hearing aid shell is a tumbling and buffing procedure (involving subjecting the shell to a barrage of fine pebbles) to smooth the shell surface which thereby makes the hearing aid fit more precise and improves comfort for the wearer. Both tumbling and buffing remove a thin layer of material from shells—however, this removal can also compromise the surface integrity of the shell.

In known custom hearing aids with RSM shells, the shell surface is constructed with a constant offset in order to compensate for the erosion of the shell material during the tumbling process. However, tumbling and buffing cause more material to be removed from the shell areas with high curvatures, because the tumbling media creates more impact to such areas. The result is that the shell geometry gets distorted, and therefore the shell does not fit well into the customer's ear.

### SUMMARY

The invention is directed to a method for manufacturing a hearing aid shell, comprising: dividing a surface of the shell into a number of predefined patches; calculating a Gaussian curvature value for each predefined patch; determining a variable offset value for each of a respective patch for a new surface, the offset value of an isosurface function being dependent on the calculated curvature value; calculating the new surface for the shell at the determined offset values; and physically creating the hearing aid shell with the new calculated surface prior to a tumbling or buffing operation.

The invention is also directed to a computer system having a processor, user interface (input and output), a memory, and algorithms that are stored in the memory and executed on the processor for implementing the method. The computer algorithms for producing the shell model can be stored on a computer readable media, such as a COD-ROM, tape, or server storage.

According to various embodiments of the invention, the method for manufacturing the shell surface is pre-distorted by offsetting it by an isosurface function. The isosurface function is directly related to the principle curvatures of the surface in order to compensate for the more aggressive tumbling of zones with high curvature. In a preferred embodiment of this system, the modifications are performed mathematically on a virtual 3-D data representation on the shell prior to the shell actually being produced. An appertaining system for implementing the method is further provided.

### DESCRIPTION OF THE DRAWINGS

FIG. 1 is a 2D pictorial representation of a custom shell with high and low curvature areas;

FIG. 2A is a 2D pictorial representation of a shell area with a high positive, low positive and high negative surface curvature, where the surface has been;

FIG. 2B is a 2D pictorial representation of a shell area and the newly-created outer surface;

FIG. 3 is pictorial isometric illustration of the regions lost during tumbling; and

FIGS. 4A&B are pictorial isometric illustrations showing a conformable region with a high propensity for material lost during tumbling, the surface being defined by a mesh with control points.

### DETAILED DESCRIPTION OF THE PREFERRED EMBODIMENTS

As noted above, and as provided according to embodiments of the invention, in the method for manufacturing, the shell surface is pre-distorted by offsetting it by an isosurface function which is directly related to the principle curvatures of the surface in order to compensate for the more aggressive tumbling of zones with high curvature. Although the drawings and descriptions rely on 2D illustrations, it should be clear that these can easily be extended to a real-world 3D model using the relevant mathematics, such as where principle eigenvectors are derived from the principal curvatures of shell surface, and a surface normal vector direction are used as an offset direction for each patch defining a zone of curvature.

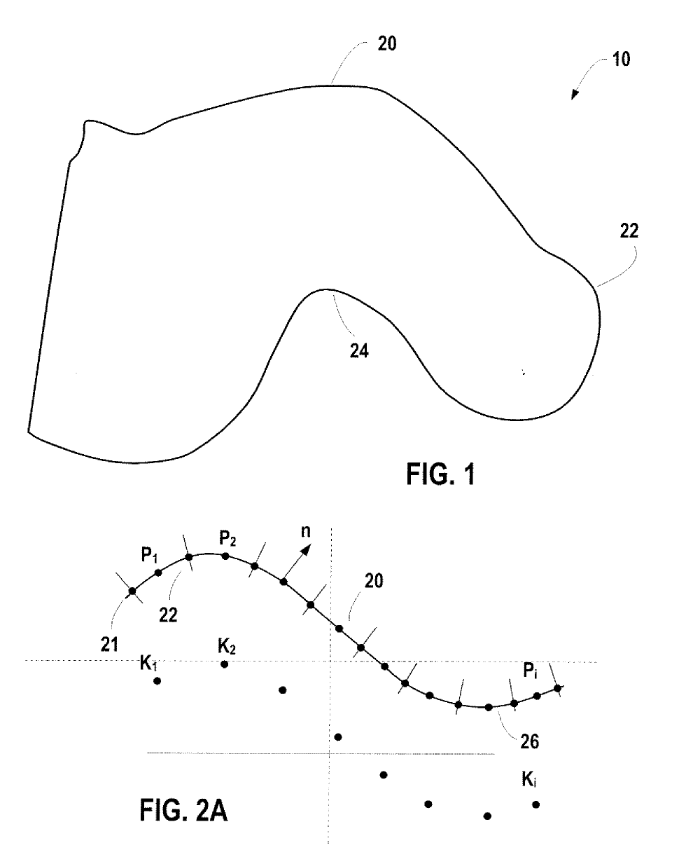

FIG. 1 illustrates a basic hearing aid shell 10 having regions with varying degrees of curvature. This figures shows an area of the shell with a low positive curvature 20, an area with a high positive curvature 22, and an area with a high negative curvature 24.

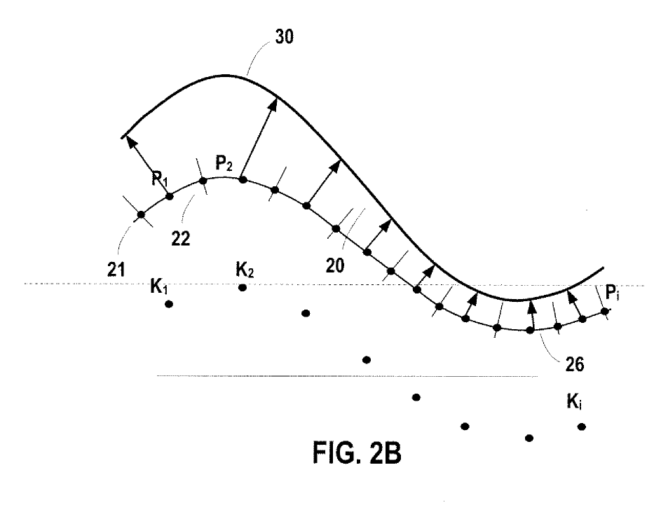

As is illustrated in FIG. 2A, the shell surface 21 is divided into small patches P₁-Pᵢ (in a preferred embodiment, the patches having an area of approximately 2 mm², although any workable size could be used) and the respective Gaussian curvatures K₁-Kᵢ are derived for each patch P₁-Pᵢ. A surface offset Qᵢ of each patch P₁-Pᵢ is then determined by a constant offset C and a variable offset f(Kᵢ), which is a function of the Gaussian curvature of the patch:

Qᵢ=C+f(Kⱼ)

This formula describes the necessary amount of the surface offset, depending on the surface curvature. It includes the concave (K is negative) and convex (K is positive) areas. The function of K reflects the erosion of the shell material form areas with various K values during tumbling. The formula includes the constant offset C and curvature-dependant offset f(K). The definition of curvature as used herein is well known in the art (see, e.g., Barrett O'Nell Elementary Differential Geometry. Academic Press NY and London 1966. Page 310-317, on Gaussian curvature).

The principal directions k are the eigenvectors of the principal Gaussian curvatures. They refer to the local orientation of the principal Gaussian curvatures, and the normal vector n can be used to identify the direction for compensation. Additionally, the shape index may be used to determined the generalized concavity and convexity and what manufacturing corrective measures are implemented. When the software, based on the curvature computation, identifies a region that is concave, then no additional material is added to this region. In the convex areas however, compensatory material is added to address the susceptibility of these localized patched regions to surface modification during tumbling.

FIG. 2B illustrates the newly-created outer surface 30. This new outer surface 30 is formed by the curvature-dependent offset Q of the initial patches P₁-Pᵢ of the surface. The surface of each individual patch Pᵢ is offset by the value derived as Qⱼ=C+f(Kⱼ). As can be clearly seen, the distance from the shell surface 21 to the new outer surface 30 is greater in areas of high positive curvature 22, less in areas of low positive curvature 20, and even less in areas of negative curvature 26. The triangular patches of the region are selected and the normals of triangles or quadrilaterals (combined triangles) in this region are extended by a defined displacement (e.g., ˜0.1-0.3 mm).

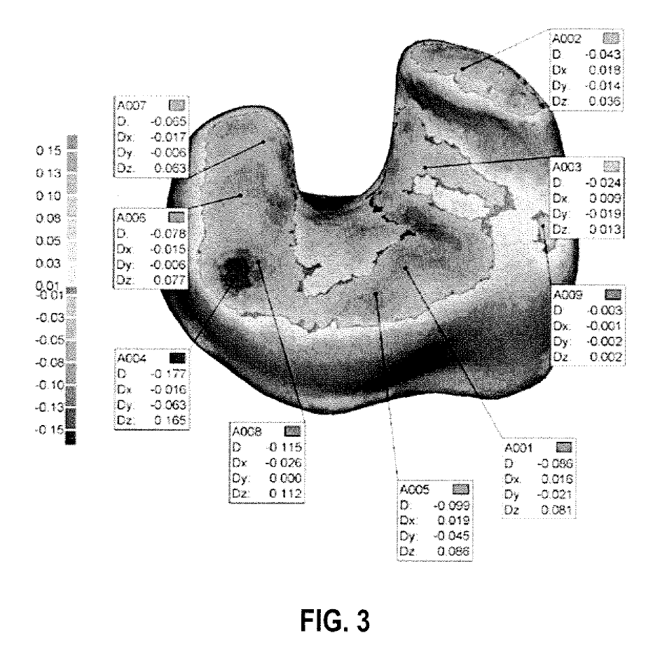

FIG. 3 illustrates the material that is lost as a result of tumbling. The regions indicated with a higher negative D value indicate areas in which a greater material removal results from tumbling. These regions represent potential low fit areas that should be corrected. Using the deviation data shown, the software model can provide for adapting a new outer surface 30 prior to tumbling to ensure the integrity of the post-tumbled finished surface.

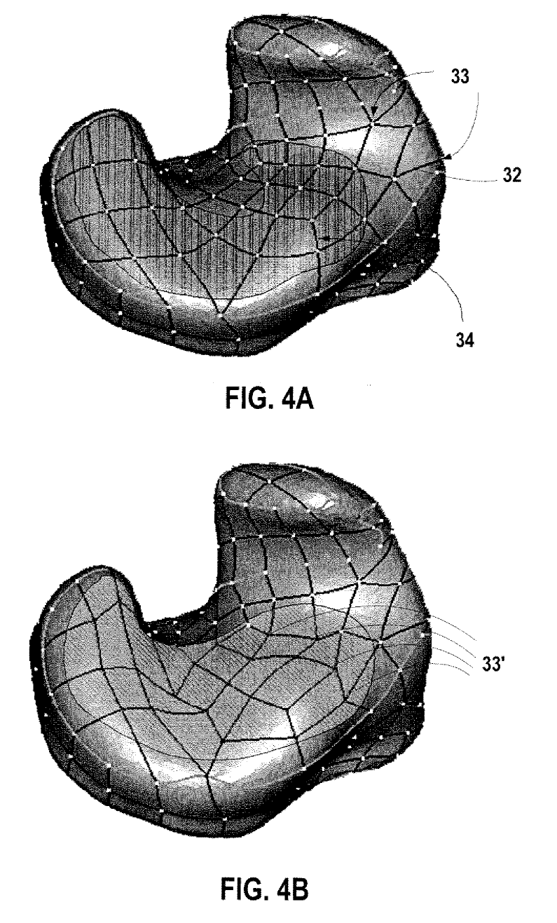

FIG. 4A illustrates a conformable region 34 with a high propensity for material loss during tumbling. A mesh 32 defines a surface of the original impression prior to tumbling and provides control points 33 that allow for material correction. The control points are generated based on stereolithography (STL) files of the shell.

This accomplished after the software system has determined the degree of curvature of the shell surface. In FIG. 4A, the region around the concha indicates high concavity. Hence, this software system meshes the surface of the shell and determines the vertices of the resulting quadrilateral meshes as the principal control points. Each rectangle has a defined normal. The system can provide a pre-configured offset value parametrically to the mesh surface. Each of the normals are displaced by the given amount to form a new surface. The new surface is then the a priori corrective factor for ensuring that during tumbling the integrity of the final shell surface is preserved.

In FIG. 4B, control points 33′ are illustrated (actually, all of the intersection points lacking a small white square) that are to be moved in a normal direction in order to accomplish the objective of preserving the surface integrity of the shell. The shape in the defined region (based of the principal curvatures) is preserved. The software of the inventive method can implement templates of these high distortable regions to allow adaptive modifications during modeling above and beyond the curvature-based modifications.

A system for implementing the above method is further provided, in which a computer system has a processor, user interface (input and output), a memory, and algorithms that are stored in the memory and executed on the processor. The algorithms are used to transform the initial shell model into the final shell model that is to be produced based on the above algorithms. The computer system has an input for entering the initial shell model, and an output for sending the final shell model to a device that can actually produce the shell model. The computer algorithms for producing the shell model can be stored on a computer readable media, such as a CD-ROM, tape, or server storage.

Although the present invention is optimally suited for virtual shells and mathematical manipulation thereon, it could theoretically be applied in any context of hearing aid shells.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The word mechanism is used broadly and is not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

TABLE OF REFERENCE CHARACTERS

| | |
|---|---|
| 10 | shell |
| 20 | shell area having a low positive curvature |
| 21 | original surface |
| 22 | shell area having a high positive curvature |
| 24 | shell area having a high negative curvature |
| 26 | shell area with a negative curvature |
| 30 | new surface |
| 32 | surface mesh |
| 33 | adjustable control points |
| 34 | conformable region |
| K₁-Kᵢ | values of a Gaussian curvature of the patches of the outer surface |
| | of the shell area (2-D view) |
| P₁-Pᵢ | patches |

What is claimed is:

1. A method for manufacturing a hearing aid shell, comprising:
dividing a surface of the shell into a number of predefined patches;
calculating a Gaussian curvature value for each predefined patch;
determining a variable offset value for each of a respective patch for a new surface, the offset value of an isosurface function being dependent on the calculated curvature value;
calculating the new surface for the shell at the determined offset values; and
physically creating the hearing aid shell with the new calculated surface prior to a tumbling or buffing operation.

2. The method according to claim 1, wherein the offset value includes a predetermined constant value in addition to the variable offset value for each patch.

3. The method according to claim 1, wherein principle eigenvectors are derived from the principal curvatures of shell surface, and a surface normal vector direction are used as an offset direction for each patch.

4. The method according to claim 1, wherein a shape index is utilized to determine a generalized concavity and convexity of patches, and those patches determined as convex are not altered.

5. The method according to claim 1, wherein the patches have a surface area of approximately 2 mm².

6. The method according to claim 1, wherein the surface offset is calculated according to the following equation:
Qⱼ=C+f(Kⱼ)
where Qⱼ is a surface offset for each patch, C is a constant offset, and f(Kⱼ) is a variable offset where K is the Gaussian curvature derived for each respective patch.

7. A computer system, comprising:
a processor;
a user interface comprising a user input and user output;
an algorithm for dividing a mathematically represented surface of a hearing aid shell into a number of predefined patches;
an algorithm for calculating a Gaussian curvature value for each predefined patch;
an algorithm for determining a variable offset value for each of a respective patch for a new surface, the offset value of an isosurface function being dependent on the calculated curvature value;
an algorithm for calculating the new surface for the shell at the determined offset values;
a memory for storing the algorithms as machine executable code to be implemented by the processor; and
an output at which data used for manufacturing a hearing aid shell is provided.

8. A computer readable media that stores computer readable instructions comprising:
an algorithm for dividing a mathematically represented surface of a hearing aid shell into a number of predefined patches;
an algorithm for calculating a Gaussian curvature value for each predefined patch;
an algorithm for determining a variable offset value for each of a respective patch for a new surface, the offset value of an isosurface function being dependent on the calculated curvature value; and
an algorithm for calculating the new surface for the shell at the determined offset values.
